(19) United States
(12) Patent Application Publication
(10) Pub. No.: US 2026/0333029 A1
(43) Pub. Date: Oct. 22, 2026

(54) METHODS, DEVICES AND SYSTEMS FOR PROVISIONING WIRELESS DEVICES THAT OPERATE WITH AMBIENT POWER

(71) Applicant: Infineon Technologies Americas Corp., El Segundo, CA (US)

(72) Inventors: Hui Luo, Marlboro, NJ (US); Rakesh Taori, McKinney, TX (US)

(73) Assignee: Infineon Technologies Americas Corp., El Segundo, CA (US)

(21) Appl. No.: 19/638,974

(22) Filed: Apr. 3, 2026

Related U.S. Application Data
(60) Provisional application No. 63/792,494, filed on Apr. 22, 2025.

(51) Int. Cl. H04W 12/041; H02J 50/00; H04L 9/06

(52) U.S. Cl. CPC H04W 12/041; H04L 9/0643; H02J 50/001

(57) ABSTRACT

A method can include, by operation of wireless circuits of an ambient powered (AMP) device, receiving at least a provision request frame having at least a source address (AA), a first nonce (ANonce), and a key identification (ID) value (PMK_ID). In addition, by operation of processor circuits and using ambient power, generating a second nonce (SNonce), computing a pairwise transient key (PTK) using at least ANonce, SNonce, AA, an address for the AMP device (SA), and a pre-shared key (PSK), deriving at least an encryption key (KEK) from the PTK, and computing a pairwise master key (PMK) using PMK_ID and a secret value (P). By operation of wireless circuits and using ambient power, a provision response frame can be transmitted that includes at least SNonce and the encrypted PMK. Corresponding devices and systems are also disclosed.

### CROSS-REFERENCE TO RELATED APPLICATIONS

The present application claims the priority and benefit of U.S. Patent Application Number No. 63/792,494 filed on Apr. 22, 2025, the contents of which are incorporated by reference herein in their entirety.

### TECHNICAL FIELD

The present disclosure relates to wireless systems, and more particularly to security operations for wireless devices having low power consumption, including but not limited to, ambient powered devices.

### BACKGROUND

Ambient devices can operate on limited power from radio-frequency (RF) energy present in an operating environment. In operation, ambient devices can accumulate limited power from RF excitation signals during a harvesting cycle.

Compared to devices having a constant power supply, ambient devices can have computation circuits of relatively low complexity. As a result, conventional security operations for ambient devices (e.g., authentication and key generation) have been proposed that use a high-entropy secret shared between an ambient device and a corresponding reader device (e.g., a device that requests upload data from the ambient device). A high-entropy shared secret can have relatively large bit size (e.g., 128-bits, preferably 512-bits).

Such conventional proposals include provisioning methods that program a high-entropy secret into the ambient device. However, writing data, even a 32-bit word, into non-volatile memory of an ambient device can take a considerable amount of energy (e.g., 50-500 Microjoules (uJ)), which can be more than an RF-harvesting ambient device can support.

It would be desirable to arrive at some way of providing secure provisioning for an ambient device, that does not include the writing of high entropy values by the ambient device.

### SUMMARY

A method can include, by operation of wireless circuits of an ambient powered (AMP) device, receiving at least a provision request frame having at least a source address (AA), a first nonce (ANonce), and a key identification (ID) value (PMK_ID). In addition, by operation of processor circuits and using ambient power, generating a second nonce (SNonce), computing a pairwise transient key (PTK) using at least ANonce, SNonce, AA, an address for the AMP device (SA), and a pre-shared key (PSK), deriving at least an encryption key (KEK) from the PTK, and computing a pairwise master key (PMK) using PMK_ID and a secret (P). A secret P can be stored in a nonvolatile fashion and not shared by the AMP device. PMK can be encrypted using the KEK. By operation of the wireless circuits and using ambient power, wirelessly a provision response frame can be transmitted that includes at least SNonce and the encrypted PMK. Corresponding devices and systems are also disclosed. Those skilled in the art will recognize additional features and advantages upon reading the following detailed description, and upon viewing the accompanying drawings.

### BRIEF DESCRIPTION OF DRAWINGS

FIG. 1-0 illustrates a signaling diagram for a system and corresponding provisioning operations for a wireless ambient powered (AMP) device according to an embodiment.

FIG. 1-1 illustrates a signaling diagram for a system and corresponding provisioning operations for a wireless AMP device according to another embodiment.

FIG. 2 illustrates a signaling diagram for a system and corresponding access operations for an AMP device according to an embodiment.

FIG. 3 illustrates a signaling diagram for a system and AMP device that can be provisioned a limited number of times, according to an embodiment.

FIG. 4 illustrates a signaling diagram for a system and AMP device that can be provisioned a limited number of times, according to another embodiment.

FIG. 5 illustrates a signaling diagram for a system and corresponding reprovisioning operations for an AMP device according to an embodiment.

FIG. 6 illustrates a signaling diagram for a system and corresponding deprovisioning operations for an AMP device according to an embodiment.

FIGS. 7-0 and 7-1 illustrates a signaling diagram for a system and corresponding provisioning operations for an AMP device according to a further embodiment.

FIGS. 8-0, 8-1 and 8-2 illustrates a signaling diagram for a system and corresponding provisioning operations for an AMP device according to another embodiment.

FIG. 9 illustrates a block diagram of an ambient device according to an embodiment.

FIG. 10 illustrates a block diagram of an ambient device according to another embodiment.

FIG. 11 illustrates an integrated circuit device according to an embodiment.

FIG. 12 illustrates an ambient device according to a further embodiment.

FIG. 13 illustrates a block diagram of an ambient device according to another embodiment.

FIG. 14 illustrates a block diagram of a reader device according to an embodiment.

FIG. 15 illustrates a block diagram of a server system according to an embodiment.

FIG. 16 illustrates a system according to an embodiment.

### DETAILED DESCRIPTION

The examples described herein provide methods, devices and systems that can execute wireless security operations between an ambient powered (AMP) device and another device (e.g., AMP reader) that can use a high entropy secret (P) in possession of the AMP device. Secret P is not received nor shared during security operations (e.g., P can be “built-in” to the AMP device). An AMP device can receive a provision request frame that includes a source address (AA), a nonce (ANonce), and a key identification value (PMK_ID), and compute a transient key (PTK) using such values, as well as its own nonce (SNonce), its own address (SA) and a pre-shared key (PSK). The AMP device can further compute a pairwise master key (PMK) using PMK_ID and secret P, and then encrypted PMK using an encryption key (KEK) derived from PTK. The AMP device can the transmit a provision response frame that includes SNonce and the encrypted PMK.

In some embodiments, a provision request frame can be a broadcast frame, and an AMP device can selectively provide a provision response frame based on validating a received hash result included in the provision request frame. In some embodiments, an AMP device can generate a first hash result using AA, PMK_ID, ANonce, and a built-in ID and compare it to the received hash result.

In some embodiments, using bootstrapping information for the AMP device (e.g., information acquired independently of the network being provisioned), an AMP reader can request and receive a pre-shared key (PSK) and AMP ID value (A_ID). Such a values can be used for provisioning operations between the AMP device and AMP reader.

In some embodiments, an AMP device can provide only a limited number of provisioning operations based on a provisioned record. Upon receiving a provisioning request, depending upon the existing provisioned record of the AMP device, a provisioning operation can proceed or be abandoned. Upon each valid provisioning operation, the ambient device can update the provisioned record.

In some embodiments, an AMP device can perform reprovisioning operations, in which a new shared secret is to be generated. Reprovisioning operations can include an AMP device making limited changes to secret P (i.e., changing a low number of bits, including one bit). A new shared secret (PMK) can be generated with the changed secret P, which can be provided to an AMP reader (in encrypted form). In some embodiments, an AMP device can perform deprovisioning operations, in which an ambient device can make limited changes to a secret P (i.e., changing a low number of bits, including one bit), thereby nullifying any existing shared secrets based on a previous value of secret P.

Such limited (e.g., low bit number) changes to secret P can be more easily accomplished with the limited power available for the AMP device than conventional approaches that may require the writing of a large number of bits.

In some embodiments, an AMP reader acquiring bootstrapping information for an AMP device can include the AMP reader accessing a server over a network, including over the Internet.

In some embodiments, a shared secret based on secret P generated by an AMP device can be relayed by another wireless device to a server system. The server system can control security operations to enable or prevent an AMP reader from accessing the AMP device.

An embodiment can include a method and system of provisioning with a device-specific shared secret (PMK) derived from an AMP device built-in secret P. Using bootstrapping information (A_ID and PSK) acquired through an OOB method, an AMP reader can receive the PMK in encrypted form.

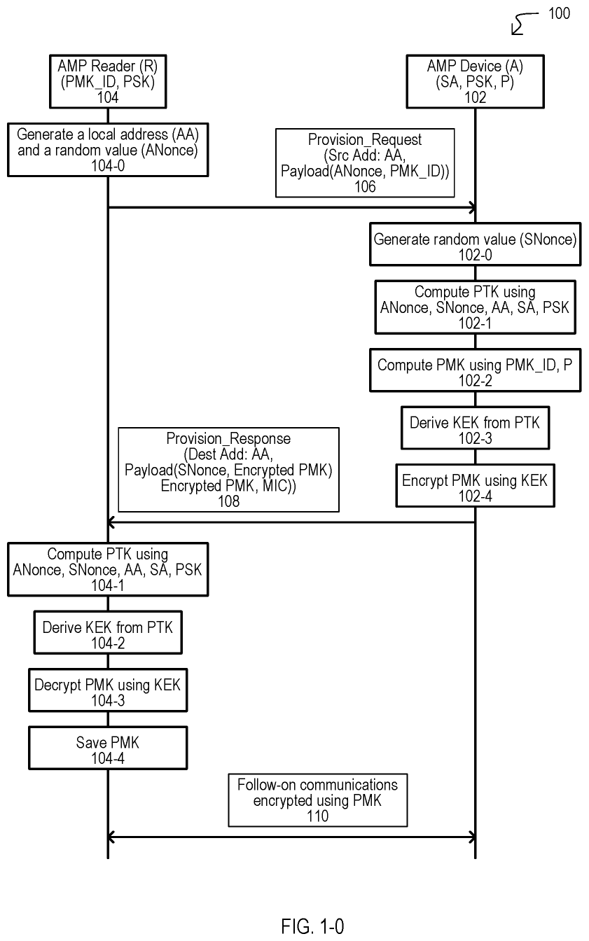

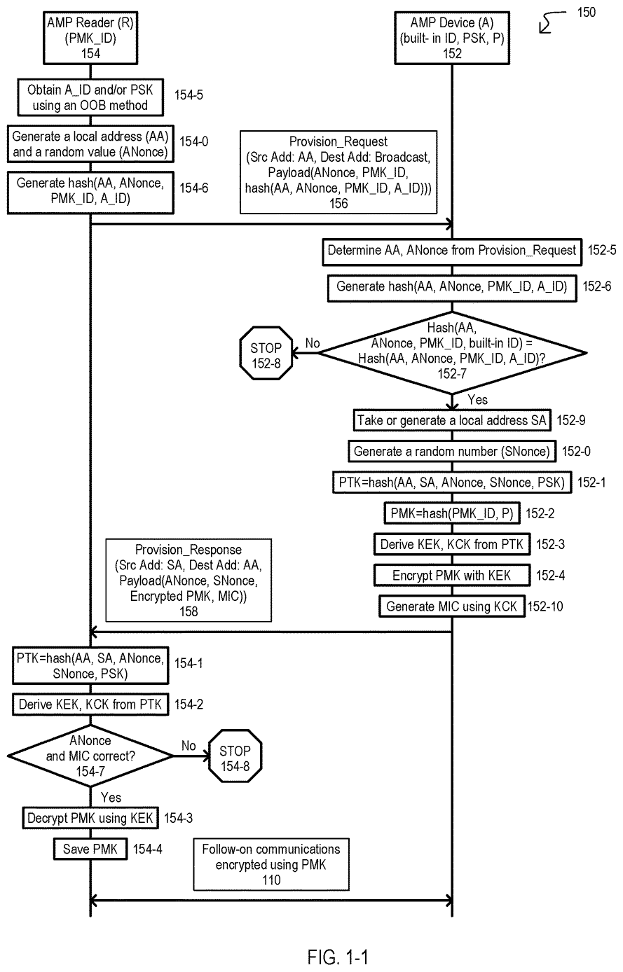

FIG. 1-0 is a signaling diagram of a system 100 and corresponding operations according to an embodiment. FIG. 1-0 shows a provisioning operation between an AMP device 102 and an AMP reader 104 that can seek upload (UL) data from AMP device 102. AMP device 102 can be in possession of a device ID (e.g., address) (SA), a pre-shared key (PSK) and a secret P. A secret P can be a value that is never provided to another device, and can be a high entropy value, such a 128-bit value or larger (e.g., 512-bits). A PSK can be a value stored by ambient device 102 that is never transmitted to other devices. However, such values can be accessible by an AMP reader 104 through other means, such as out-of-band (OOB) methods, as will be described herein. AMP reader 104 can store a key ID value (PMK_ID) and can acquire PSK.

An AMP reader 104 can generate or access a local address (AA) and generate a random value, which can be a nonce (ANonce) 104-0. A nonce can be an essentially random value that is not repeated. Local address AA can be an address for use in the wireless method of the provision request. In some embodiments, a method being provisioned can be compatible with one or more IEEE 802.11 wireless standards.

AMP reader 104 can wirelessly transmit a provision request frame 106. A provision request frame 106 can have AA as a source address and include ANonce and PMK_ID.

Upon receiving provision request 106, AMP device 102 can compute its own random value 102-0, which can be a nonce (SNonce). AMP device 102 can also compute a transient key (PTK) using ANonce, SNonce, AA, SA, and PSK 102-1. AMP device 102 can compute a pairwise master key (PMK) using PMK_ID and secret P 102-2. Thus, PMK can be specific to AMP device 102 as secret P can be unique and secret to AMP device 102. From a resulting PTK, an encryption key (KEK) can be derived 102-3. PMK can be encrypted using KEK 102-4.

AMP device 102 can wirelessly transmit a provision response frame 108. A provision response frame 108 can have AA as a destination address. A provision response frame 110 payload can include SNonce and encrypted PMK.

Upon receiving provision response frame 110, AMP reader 104 can compute PTK 104-1, and derive KEK 104-2 in the same fashion as AMP device 102. AMP reader 104 can decrypt PMK using KEK 104-3, and then save PMK 104-4 for future communications with AMP device 110.

In this way, an AMP device can receive a provision request with a random value and key identification value. Using at least the received random value, its own random value, and a pre-shared secret value, the AMP device can derive an encryption key. Using its own secret P and the key identification value, AMP device can compute a master key value. The master key value can be encrypted with the encryption key and transmitted to the requesting device along with the random value generated by the AMP device.

FIG. 1-1 is a signaling diagram of a system 150 and corresponding operations according to another embodiment. FIG. 1-1 shows a provisioning operation between an AMP device 152 and an AMP reader 154 that can be a variation and/or implementation of that shown in FIG. 1-0. AMP device 152 can be in possession of a built-in ID, a PSK and a secret P. A secret P can have characteristics like those described in FIG. 1-0 (e.g., high-entropy). A PSK and built-in ID can be values stored by ambient device 152, that are never transmitted to other devices. However, such values can be accessible by an AMP reader 104 through other means, such as out-of-band (OOB) methods, as will be described herein. AMP reader 154 can store PMK_ID, which can be used in the provisioning operation, as is described herein.

In a provisioning operation, an AMP reader 154 can obtain values A_ID and PSK corresponding to AMP device 152, using an OOB method 154-4. A value A_ID can correspond with, or be identical to, the built-in ID of AMP device 152. PSK can also be a high entropy value. An OOB method can be any suitable method that differs from the method being provisioned. In some embodiments, value A_ID and/or PSK can be physically associated with AMP device 152 (e.g., included in the packaging of, or included on the AMP device 102 itself). An OOB method can directly, or indirectly access values A_ID and/or PSK. Indirect access can include an AMP reader 154 sensing initial information from an AMP device 102 (or its associated materials) which can direct the AMP reader 154 to another location where the actual values can be accessed (i.e., over a network). OOB methods can include, but are not means limited to, reading a quick response (QR) code, accessing an indicated uniform resource locator (URL), or reading a radio frequency ID (RFID) code.

An AMP reader 154 can generate or access a local address (AA) and generate a random value, which can be a nonce (ANonce) 154-0. Local address AA can be an address for use in the wireless method of the provision request. Once in possession of A_ID, AMP reader 104 can also execute a hash operation 154-6 using AA, ANonce, PMK_ID and A_ID, to generate a hash result (hash(AA, ANonce, PMK_ID, A_ID)) which will be sent to AMP device 102.

AMP reader 104 can wirelessly transmit a provision request frame 156. A provision request frame 156 can have AA as a source address and a broadcast address as a destination address. A broadcast address can be an address that can be a valid destination address for multiple AMP devices. A provision request frame 156 payload can include ANonce, PMK_ID and hash(AA, ANonce, PMK_ID, A_ID).

From the broadcast destination address, AMP device 152 can determine it is a valid destination for the provision request frame 156, and so receive such a frame. AMP device 152 can determine from the provision request frame 156, the values AA, ANonce and the received hash value (hash(AA, ANonce, PMK_ID, A_ID)) 152-5. AMP device 152 can execute a hash operation using the received AA, ANonce, PMK_ID values, along with its own built-in ID to generate its own internal hash result (hash(AA, ANonce, PMK_ID, built-in ID) 152-6. In some embodiments, such hash operations (e.g., 154-6, 152-6) can use a cryptographic hash function that is relatively light-weight with respect to computation resources, such as one selected from the Ascon suite. In some embodiments, PMK_ID can indicate a type of hash operation for AMP device 152.

AMP device 152 can compare its internal hash result (i.e., one that used its built-in ID value) to a received hash result of the provision request frame (i.e., one that used A_ID from an OOB operation) 152-7. If such hash values do not match (No from 152-7), a provision operation can stop 152-8.

If a received hash and a locally generated hash value match (Yes from 152-7), AMP device 152 can generate values for a provision response frame. Such values can include a source address (SA) 152-9 and generating another random value (SNonce) 152-0. A value SA can be generated independently by AMP device 152 or based on criteria indicated by a provision request 156. AMP device 152 can then generate PTK with a hash operation that uses AA, SA, ANonce, SNonce, and PSK 152-1.

AMP device 152 can generate a PMK with a hash operation that uses PMK_ID and secret P. From a PTK, encryption key KEK and a confirmation key (KCK) can be derived 152-3. PMK can be encrypted using KEK 152-4. In some embodiments, the encryption of PMK can use an encryption function that is advantageously lightweight with regard to computation resources, such as one present in the Ascon suite. In the embodiment shown, once data for a provision response frame has been created, AMP device 152 can generate a corresponding message integrity code (MIC) using KCK 152-10.

AMP device 102 can wirelessly transmit a provision response frame 158. A provision response frame 158 can have SA as a source address and a AA as a destination address. A provision response frame 158 payload can include ANonce, SNonce, encrypted PMK, and the corresponding MIC.

Upon receiving provision response frame 158, AMP reader 154 can generate PTK 154-1, and determine KEK and KCK 154-2 in the same fashion as AMP device 152, using PSK acquired through an OOB method. AMP reader 154 can then validate the received provision response by checking for a valid ANonce and MIC 154-7. This can include an AMP reader 104 generating its own MIC using KCK, and comparing it to the received MIC. If the provision response is not valid (No from 154-7), AMP reader 154 can stop the provision operation 154-8.

If the provision response is determined to be valid (Yes from 154-7), AMP reader 154 can decrypt PMK using KEK 1545-3, and then save PMK for future communications with AMP device 154-4. AMP device 152 can now be provisioned to a network, and accessed by AMP reader 154 to acquire DL data through follow communications which can be encrypted using PMK 110.

Referring still to FIG. 1-1, in brief, a provision operation can begin assuming that AMP device 152 has a serial number (i.e., A_ID), a bootstrapping secret (i.e., PSK), and a secret P when it is manufactured. All of these values can be high-entropy values. A_ID and PSK can be accessible by a legitimate AMP reader using an OOB method during bootstrapping and may be printed as a QR code on packaging for AMP device 152.

In the provisioning operation, AMP reader 154 can use or generate a local address AA. AMP device 154 can use a local address SA. Either or both such addresses can be randomly generated or specified by AMP reader 154.

A provisioning operation can include AMP reader 154 fetching confidential values A_ID and PSK using an OOB method. AMP Reader can broadcast a provisioning request frame, containing its local address AA, ANonce, PMK_ID, and hash(AA, ANonce, PMK_ID, A_ID). A provision request can be a broadcast frame because if SA is specified by AMP reader, AMP device will need such information for a provision response. Conversely, if SA is generated by AMP device, an AMP reader does not yet have such information.

Devices receiving a broadcast provisioning request frame can compute hash(AA, ANonce, PMK_ID, built-in ID) using their built-in ID. Only the AMP device 152 having a built-in ID corresponding to A_ID can determine that its computed hash value equals the received hash value. Such an AMP device 152 can then send back a provisioning response frame using SA as its local address, and containing ANonce, SNonce, and PMK encrypted by a key KEK generated from hash(AA, SA, ANonce, SNonce, PSK). PMK can be generated from hash(PMK_ID, P).

After receiving a provisioning response frame, an AMP reader 154 can generate the same KCK and KEK independently from hash(AA, SA, ANonce, SNonce, PSK), verify the MIC, decrypt PMK, and then save PMK as a shared secret with the AMP device 152.

In this way, using a high entropy secret value that is never shared (e.g., secret P), an AMP device can generate a high-entropy shared secret (PMK). The shared secret can be encrypted with confidential values (e.g., PSK) and transmitted to a requesting (e.g., reader) device. The requesting device can acquire the confidential values through an OOB operation to decrypt and save the shared secret. In such a provision operation, an AMP device does not have to store a high-entropy shared secret in non-volatile memory.

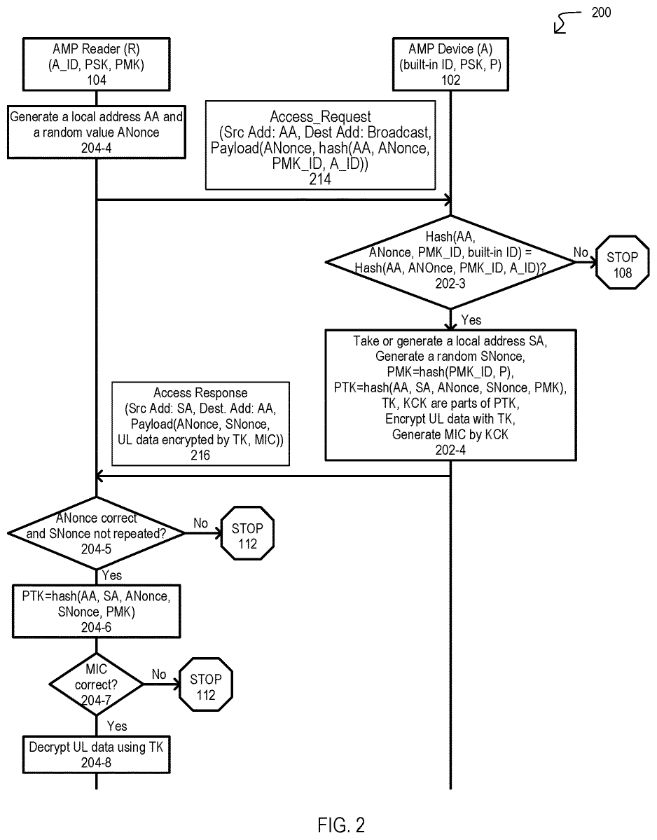

FIG. 2 is a signaling diagram showing a system 200 and corresponding access operations according to an embodiment. A system 200 can correspond to that shown in FIGS. 1-0 and/or 1-1, following a successful provisioning operation. As such, an AMP reader 104 can be in possession of a shared secret PMK based on non-shared secret P stored by AMP device 102. An AMP reader 104 can seek to receive UL data from AMP device 102.

In an access operation, an AMP reader 104 can generate or access a local address (AA) and generate a random value, which can be a nonce (ANonce) 204-4. A local address AA can be the same as, or different than that used in a previous provisioning operation (i.e., like that of FIGS. 1-0/1-1). ANonce can be different from that used in a previous provisioning operation.

AMP reader 104 can wirelessly transmit an access request frame 214. An access request frame 214 can have AA as a source address and a broadcast address as a destination address. A broadcast address can be the same as, or different from, that used for a previous provision request. An access request frame 214 payload can include ANonce and a hash(AA, ANonce, PMK_ID, A_ID). In some embodiments, such a payload can also include a PMK_ID.

AMP device 102 can determine, from the access request frame 214, AA, ANonce and the received hash value (hash(AA, ANonce, PMK_ID, A_ID)). AMP device 102 can execute a hash operation using the received AA, ANonce, PMK_ID values, along with its own built-in ID to generate its own internal hash result (hash(AA, ANonce, PMK_ID, A_ID). Such actions can follow those shown as 102-00/01 in FIG. 1-1. AMP device 102 can compare the internal hash result to a received hash result of the access request frame 202-3. If such hash values do not match (No from 202-3), an access operation can stop 108.

If a received and locally generated hash value match (Yes from 202-3), AMP device 102 can generate values for an access response frame 202-4. Such values can include a SA and a nonce SNonce. A value SNonce can be different than that included in a provision response. A value SA may or may not be the same as that used for a previous provision response. AMP device 102 can also generate a PMK using P and PMK_ID. AMP device 102 can then generate a PTK with a hash operation that uses AA, SA, ANonce, SNonce, and PMK. From a resulting PTK, a temporal key TK and KCK can be determined. UL data can be encrypted using TK. As in the case of the encryption of PMK, the encryption of UL data can use an encryption function that is advantageously lightweight with regard to computation resources. In the embodiment shown, once data for an access response frame can be organized, AMP device 102 can generate a corresponding message integrity code (MIC) using KCK.

AMP device 102 can wirelessly transmit an access response frame 216 having SA as a source address and a AA as a destination address. A provision response frame 216 payload can include ANonce, SNonce, encrypted UL, and the corresponding MIC.

Upon receiving an access response 216, AMP reader 104 can determine if ANonce in the payload is correct (i.e., it matches that sent in the access request 214) and if SNonce received in the payload is not a repeated value 204-5. If either determination fails, an access operation can stop 112. If ANonce is correct and SNonce is not repeated (Yes from 204-5), AMP reader 104 can generate PTK and determine TK and KCK in the same fashion as AMP device 102. Using KCK, access device 104 can determine if a MIC from the access response is correct 204-7. If such a value is not correct (No from 204-7), an access operation can stop 112. If a MIC value is correct (Yes from 204-7), UL data can be decrypted using TK 204-8.

In this way, a shared secret can be received and stored by an AMP reader in a provisioning operation, where the shared secret is based on a high-entropy secret that stored but not shared by an AMP device. Such a shared secret can be used by the AMP reader in subsequent access operations to the AMP device.

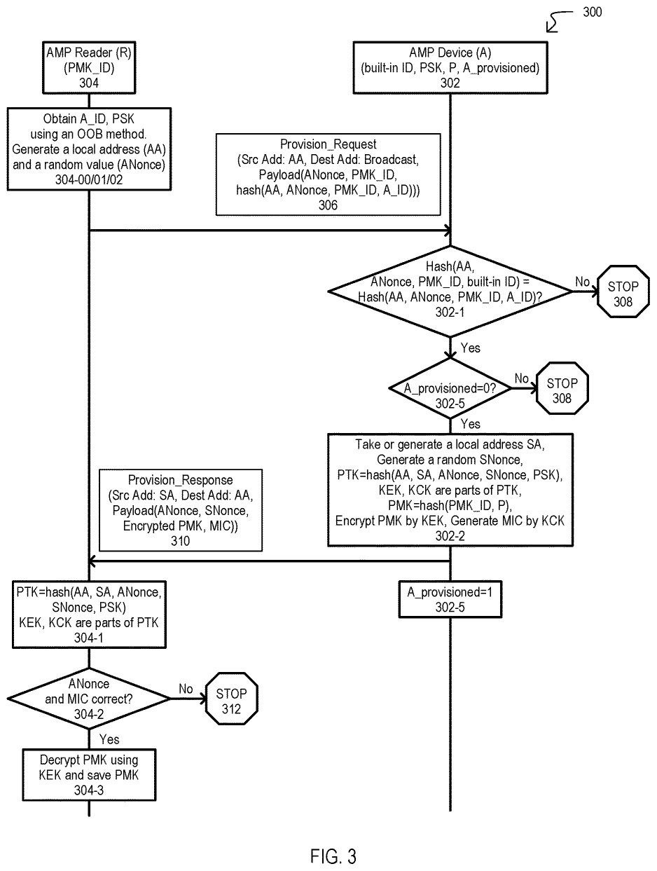

FIG. 3 is a signaling diagram showing a system 300 and operations according to another embodiment. A system 300 can provide for security based on a high entropy value stored but not shared by an AMP device as in FIG. 1-1, but the number of times an AMP device can be provisioned may be limited.

FIG. 3 can differ from FIG. 1-1 in that an AMP device 302 can further store a provisioned record (A_provisioned), which can be used to limit a number of times AMP device 302 is provisioned. In the embodiment shown, A_provisioned can be a single bit value, initially set to a predetermined value, “0” in the embodiment shown. Operations can differ from those of FIG. 1-1 in that, following a comparison between a received hash value and an internally generated hash value 302-1, AMP device 302 can examine A_provisioned 302-5. If AMP device 302 has been previously provisioned, A_provisioned will not have the predetermined value (i.e., be 0) (No from 302-5), and a provisioning operation can stop 308. If AMP device 302 has not been previously provisioned, A_provisioned will have the predetermined value (i.e., be 0) (Yes from 302-5), and an AMP device 302 can generate a provision response 310.

Operations can further differ from those of FIG. 1-1, in that after transmitting a provision response 310, AMP device 302 can set A_provisioned to a different value (e.g., from 0 to 1) 302-5. In some embodiments, such an action can include the writing of one bit value in a nonvolatile memory.

Thus, in an embodiment like that of FIG. 3, an AMP device can have a one-bit flag (e.g., A_provisioned) set to one value (e.g., 0) in a nonvolatile memory when the AMP device is manufactured. A nonvolatile memory can include a memory that is one-time programmable (OTP) or reprogrammable. If A_provisioned as one value (e.g., 0), an AMP device can run through a bootstrapping protocol, then set A_provisioned to the other value (e.g., 1).

In this way, an AMP device that uses a high-entropy secret to generate a high entropy shared secret with a reader device in a provision operation can limit the number of provision operations by setting a one-bit provisioned record after a successful provisioning operation.

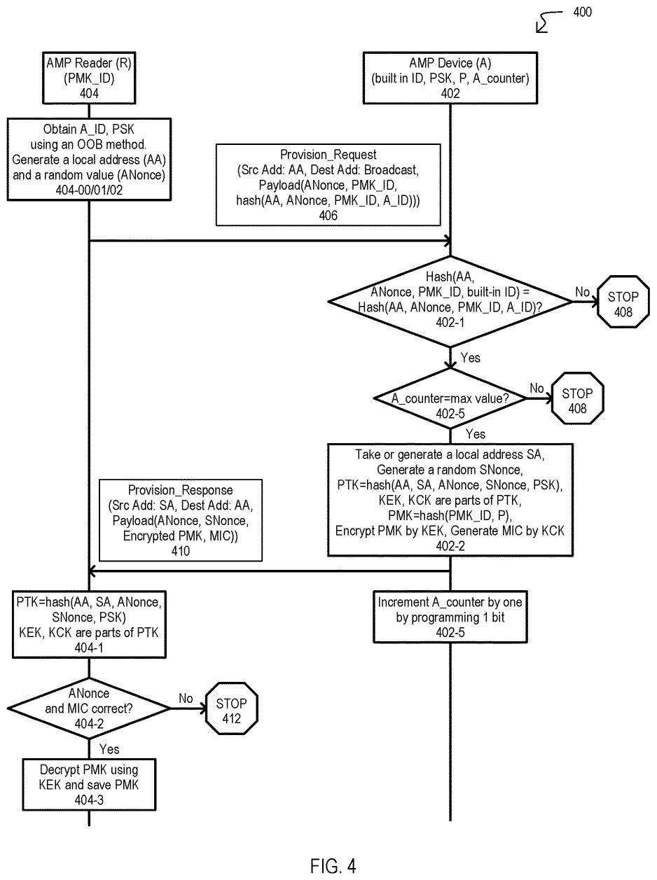

FIG. 4 is a signaling diagram showing a system 400 and operations according to another embodiment. A system 400 can provide for security based on a high entropy values stored but not shared by an AMP device, but can limit the number of times an AMP device can be provisioned. FIG. 4 includes items like those of FIG. 3, and such like items are referred to by the same reference character but with the leading digit being “4” instead of “3”.

A system 400 and operations can differ from that of FIG. 3 in that an AMP device 102 can include a provision record (A_counter) that is a count value which can be incremented with each provisioning operation until a maximum value is reached. Accordingly, following a comparison between a received hash value and an internally generated hash value 402-1, AMP device 402 can examine A_counter 402-5. If A_counter has reached a limit (No from 402-5), a provisioning operation can stop 408. If AMP device 402 has not yet reached a limit (Yes from 402-5), an AMP device 402 can generate a provision response 410. After transmitting a provision response 410, AMP device 402 can increment A_counter 402-5. In some embodiments, such an operation can involve programming only one bit. In some embodiments, A_counter can be generated with a Grey counter or equivalent.

Thus, in an embodiment like that of FIG. 4, an AMP device can have an N-bit Grey counter set to 1 in a nonvolatile memory of an AMP device. In some embodiments, such an action can be taken by writing into bit locations of a nonvolatile memory array of an AMP device when such a device is manufactured. In other embodiments, an N-bit OTP array can be used.

If a Grey counter is not 0, AMP device can run through a bootstrapping protocol, then increment the Grey counter by changing one bit.

In this way, an AMP device that uses a high-entropy secret to generate a high entropy shared secret with a reader device in a provision operation, can limit the number of provision operations by with a counter value that can be incremented after each successful provisioning operation.

Embodiments can further include reprovisioning and deprovisioning capabilities that utilize small bit changes (i.e., low power operations) to a secret (i.e., P) stored in nonvolatile memory of an AMP device. A reprovisioning operation can essentially “reset” an AMP device for use in a network. A deprovisioning operation can prevent an AMP device from operating in a network.

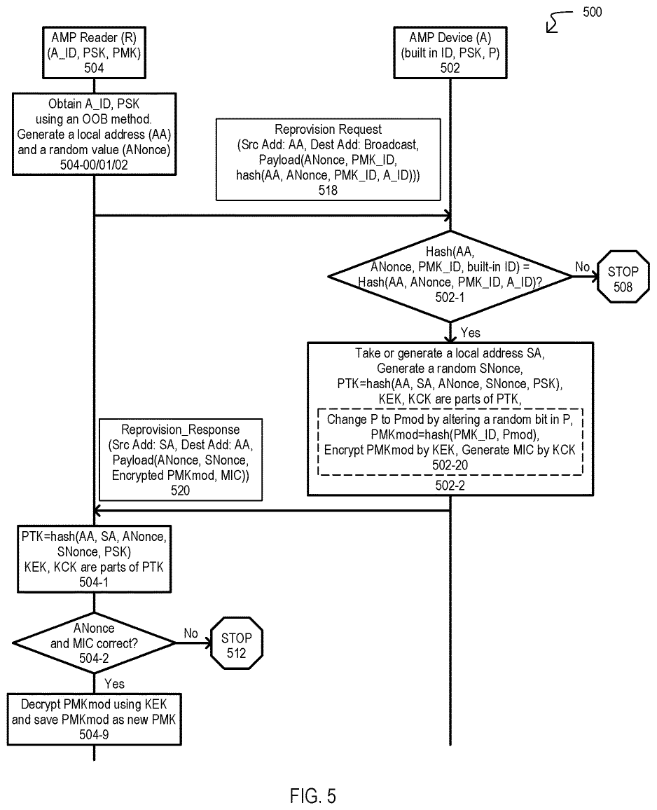

FIG. 5 is a signaling diagram showing a system 500 and corresponding reprovisioning operations according to an embodiment. A system 500 can correspond to that shown in FIG. 1-1, following a successful provision operation. Reprovisioning can take place after a previous provision operation. As such, an AMP reader 504 can be in possession of a shared secret PMK based on the secret P stored by AMP device 502. In the reprovisioning operation, an AMP reader 504 can seek to reestablish security values (i.e., PMK) for AMP device 502.

In a reprovisioning operation, like a provisioning operation, an AMP reader 504 can generate or access a local address (AA) and generate a random value, which can be a nonce (ANonce) 504-4. A local address AA can be the same as, or different than that used in a previous provisioning operation (i.e., like that of FIG. 1). ANonce can be different from that used in a previous provisioning operation.

AMP reader 504 can wirelessly transmit a reprovisioning request frame 518. A reprovisioning request frame 518 can have AA as a source address and a broadcast address as a destination address. A broadcast address can be the same as, or different from, that used for a previous provision request. A reprovisioning request frame 518 payload can include ANonce, PMK_ID, and a hash(AA, ANonce, PMK_ID, A_ID). A PMK_ID can be the same as, or different from that used in a provisioning operation.

Like a provisioning operation, an AMP device 502 can determine if an internally calculated hash value matches a received hash value 502-1. If such hash values match (Yes from 502-1), AMP device 502 can reprovision itself and generate values for a reprovision response frame 502-2. Such an action can include operations like those of FIG. 1-1, including generating an SA, SNonce, PTK, KEK and KCK.

Unlike a provisioning operation, in a reprovisioning operation, AMP device 502 can execute reprovisioning operations 502-20. Reprovisioning operations can include changing a secret P by altering a small number of bits, including only one bit, to create a modified secret Pmod. A new PMK value (PMKmod) can be generated with a hash operation that uses PMK_ID and Pmod. PMKmod can then be encrypted using KEK. In the embodiment shown, once data for a reprovision response frame has been organized, AMP device 502 can generate a corresponding message integrity code (MIC) using KCK. AMP device 505 can wirelessly transmit a reprovisioning response frame 520 having SA as a source address and a AA as a destination address. A reprovisioning response frame 520 payload can include ANonce, SNonce, the encrypted PMKmod, and the corresponding MIC.

Upon receiving a reprovisioning response frame 520, AMP reader 504 can perform operations like those described for a provisioning operation (504-1, 504-2), but PMKmod can be decrypted and PMKmod stored as a new PMK.

Thus, in an embodiment like that of FIG. 5, an AMP device can have a high entropy secret value saved in nonvolatile memory that can be altered by changing a small number of bits (e.g., less than four, as small as one). In the case of a reprogrammable memory, such changed bits can be toggled between different values. In the case of an OTP memory, such changes are understood to be one way.

In some embodiments, in response to receiving a reprovision request frame, an AMP device can randomly toggle one bit of secret P in its nonvolatile memory to create Pmod. It can then send a new shared secret based on such a changed value (e.g., PMKmod=hash(PMK_ID, Pmod)).

In this way, an AMP device can be reprovisioned by making low-bit (i.e., low power consumption) changes to a secret P. A new shared secret can then be generated using the changed secret value and provided, in an encrypted form, to an AMP reader in a reprovision response.

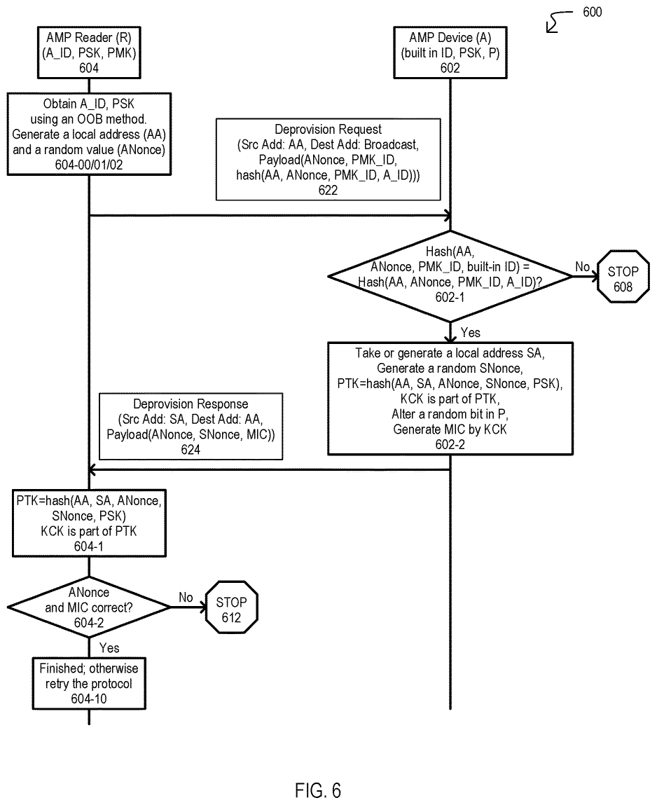

FIG. 6 is a signaling diagram showing a system 600 and corresponding deprovisioning operations according to an embodiment. A system 600 can correspond to that shown in FIG. 5 and like items are referred to by the same reference character but with the leading digit being a “6” instead of a “5”.

In a deprovisioning operation, AMP reader 604 can wirelessly transmit a deprovisioning request frame 622. A deprovisioning request frame 622 can have AA as a source address and a broadcast address as a destination address, and a payload with ANonce, PMK_ID, and a hash(AA, ANonce, PMK_ID, A_ID).

AMP device 602 can execute deprovisioning operations 602-2. Deprovisioning operations can include generating SA, SNonce and PTK, as the case of FIG. 5. However, there can be no need for the generation of a PMK, and KEK may not be needed. A MIC can be generated using KCK as in the case of FIG. 5. A deprovisioning response frame 624 payload can include ANonce, SNonce, and a corresponding MIC.

Upon receiving a deprovisioning response frame 624, AMP reader 604 can perform operations like those described for a provisioning operation (604-1, 604-2), but AMP reader 604 can then finish communications and/or retry 604-10, as there is no shared secret to store.

Thus, in an embodiment like that of FIG. 6, in response to receiving a deprovision request frame, an AMP device can randomly toggle one bit of secret P in its nonvolatile memory, without sending back a shared secret (e.g., PMK).

In this way, an AMP device can be deprovisioned by making low-bit changes to a secret P used to generate a shared secret in a provisioning protocol.

According to embodiments, a provisioning method can include an AMP reader using an OOB method to access server information for an AMP device. The AMP reader can then relay provisioning data between and server and AMP reader, where the AMP device generates a shared secret with the server based on a built-in high-entropy secret P.

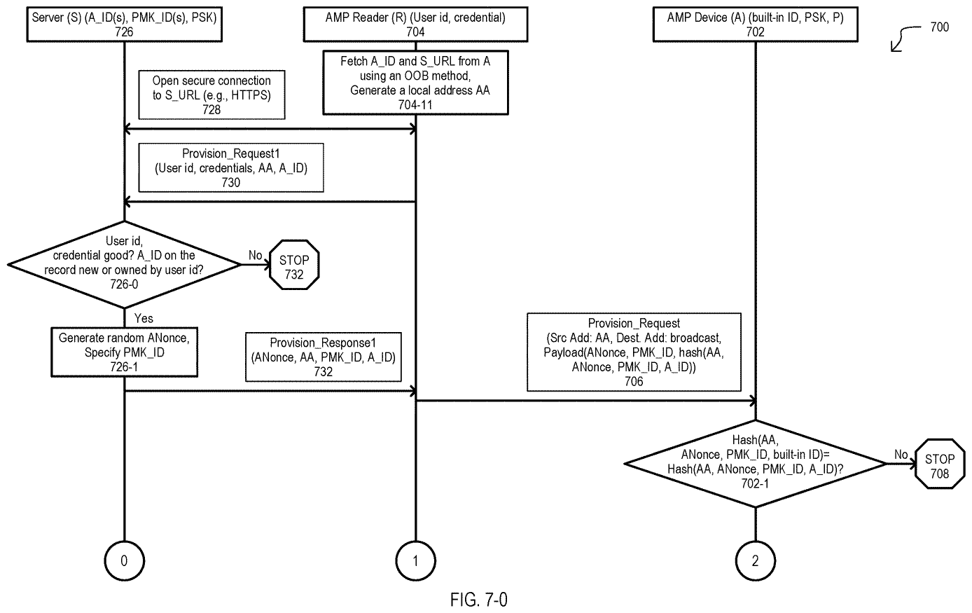

Referring to FIGS. 7-0 and 7-1 a system and operations according to another embodiment are shown in a flow diagram. A system 700 can include items and operations like those of FIG. 1-1. FIG. 7-0 is connected to FIG. 7-1 at locations shown by circles labeled 0, 1 and 2.

A system 700 can include an AMP device 702, an AMP reader 704 and a server 726. Unlike the system of FIG. 1-1, AMP reader 704 can store a user ID and credential. In some embodiments a credential can include a digital certificate, or the like. A server 726 can include a PSK, one or more PMKs, and one or more A_IDs, including an A_ID corresponding to a built-in ID of AMP device 702.

A provisioning operation can include AMP reader 704 fetching an A_ID and server information (in this case a URL) using an OOB method, and then generating a local address AA 704-11. AMP reader 704 can establish a secure connection to server 728 over one or more networks. Such a secure connection can be created over one or more wireless networks, wired networks, or combinations thereof, including the Internet. Such an action can include any suitable protocol, including but not limited to HTTPS.

Once a secure connection is established, an AMP reader 704 can transmit a server provision request 730 to server 726 over the secure connection. A provision request 730 can include a user ID and credentials for the AMP reader 704, as well as the created AA and A_ID value.

A server 726 can determine if the server provision request is valid 726-0. In the embodiment shown, such an action can include a server determining if the received credential is valid. In addition, the received A_ID value can be checked to determine if it is new or owned (or otherwise authorized) for the provided user ID. If the server request is determined to be invalid (No from 726-0), communications with the AMP reader 704 can stop 732.

If the server request is determined to be valid (Yes from 726-0), server 726 can generate a random value (ANonce), and specify a PMK_ID 726-1. A server 726 can then transmit a server provision response 732 over the secure connection that includes ANonce, AA, the selected PMK_ID and A_ID.

Upon receiving the server provision response 732, operations can proceed as described for FIG. 1-1, with AMP reader 704 transmitting a provision request 706, AMP device 702 executing a hash compare result 702-1, generating values for a provision response, including a PMK 702-2, and transmitting a provision response 710 that can include an encrypted PMK.

Referring to FIG. 7-1, unlike FIG. 1-1, upon receiving provision response 710, AMP reader 704 can send a second server provision request 734 to server 726 over the secure connection. A second server provision request 734 can include ANonce, SNonce, AA, SA, an encrypted PMK and a MIC.

Upon receiving a second server provision request 734, a server 726 can generate a PTK and determine a KEK and KCK 726-2 in the same manner as AMP device 702. If the ANonce does not match that sent previously, or the MIC is not correct (No from 726-3), server 726 can transmit an error provision response 736 that can include ANonce, AA and an error indication. If ANonce matches and the MIC is correct (Yes 726-3), server 726 can decrypt the PMK using KEK 726-4, and transmit a second server provision response 738 to AMP reader 704 over the secure connection. Second server provision response 738 can include ANonce, AA, PMK_ID and the decrypted PMK.

Upon receiving second server provision response 738, AMP reader 704 can be provisioned and access AMP device 702 using PMK in any suitable fashion, including that shown as 200 in FIG. 2.

In this way, an AMP reader can access server and device information for an AMP device through an OOB method. The AMP reader can then relay an encrypted shared secret from the AMP device to the server. The server can provide the decrypted shared secret to the AMP reader, which can then communicate further with the AMP reader using the shared secret.

According to embodiments, to access an AMP device, an AMP reader can first contact a server having a shared secret with the AMP device. If granted access, the AMP device can encrypt UL data using the shared secret, which can be relayed to the server by the AMP reader. The server can decrypt the UL data with the shared secret and transmit it to the AMP reader. In such an arrangement, the AMP reader never has access to the shared secret.

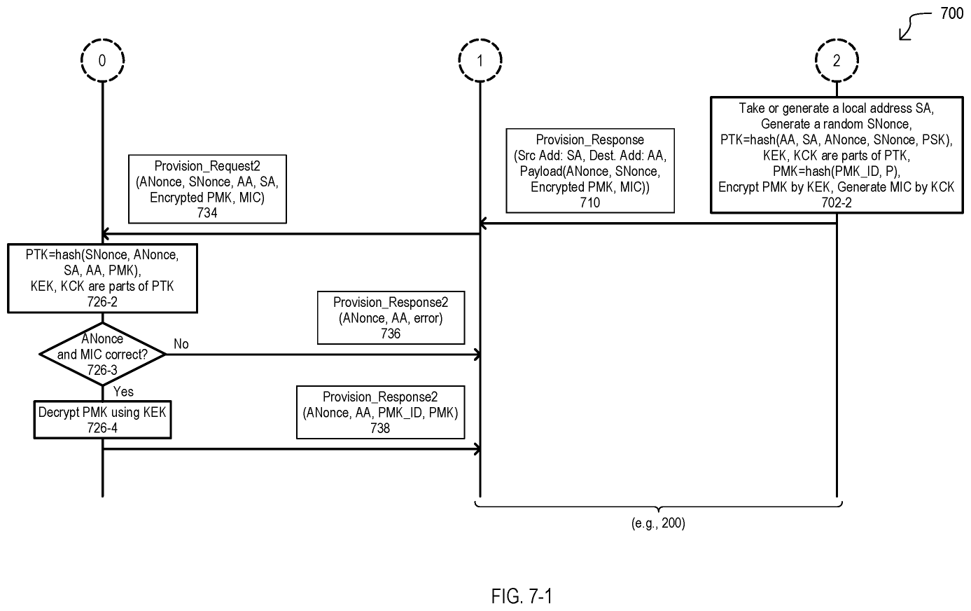

Referring to FIGS. 8-0, 8-1 and 8-2, a system and operations according to another embodiment are shown in a flow diagram. A system 800 can include items and operations like those of FIGS. 7-0 and 7-1, and such like items and operations are referred to by the same reference characters but with the leading digit being an “8” instead of a “7”. FIG. 8-0 is connected to FIG. 8-1 at locations shown by circles labeled 0-0, 1-0 and 2-0. FIG. 8-1 is connected to FIG. 8-2 at locations shown by circles labeled 0-1, 1-1 and 2-1.

A system 800 can include an AMP device 802, an AMP reader 804 and a server 826. Unlike the system of FIGS. 7-0/7-1, a server 826 can be in possession of one or more shared secrets (PMK(s)), including a PMK used by AMP device 802. In some embodiments, such a shared PMK can be obtained by server 826 in a provisioning operation with an entity in control of AMP device 802, such as a manufacturer, owner or operator of AMP device 802. In some embodiments, a server 826 can be co-located on an access point device (AP) of a corresponding network. A server 826 can manage whether an AMP reader 804 can read data from an AMP device 802 based on an ID value and credential for the AMP reader 804 (i.e., R_ID and R_credential).

AMP reader 804 can be an AMP enabled station device (STA), including a non-AP STA associated with an AP of a network, or the AP of the network. Unlike other embodiments, an AMP reader 804 may not know PMK_ID or A_ID. For example, AMP reader 804 may not perform any OOB operation to access an A_ID value. However, AMP reader 804 can be in possession of a meaningful name for an AMP device (A_name). Such a name (A_name) can be considered meaningful in that a server 826 can determine a device ID (A_ID) for the AMP device 802 from A_name.

Referring to FIG. 8-0, an access operation can include AMP reader 804 using a local address for itself (AA) 804-12. Such an action can include a preexisting value and/or can be generated by AMP reader 804. AMP reader 804 can transmit an ID request 836 to server 826. An ID request can include R_ID, R_credential, AA and A_name.

In response to ID request 836, server 826 can determine if an AMP reader 804 is allowed to read AMP device 826-5. Such an action can use R_ID and R_credential. If AMP reader 804 is determined not to be allowed access an AMP device 802 (No from 832), an operation can stop 832. If AMP reader 804 is determined to be allowed to access an AMP device 802 (Yes from 832), a server 826 can generate a random value (ANonce), and then determine A_ID from the received A_name 826-6. Server 826 can then transmit an ID response 838 to AMP reader 804. An ID response 838 can include AA, ANonce, PMK_ID, and A_ID, and a hash value (hash(AA, ANonce, PMK_ID, A_ID)). Upon receiving ID response 838, AMP reader 804 can transmit an access request 806, like that of FIG. 7.

AMP device 802 can make a hash comparison 802-1 as described in FIG. 7. If a received hash value matches an internally generated hash value (Yes from 802-1), AMP device 802 can generate values for an access result. Referring to FIG. 8-1, such operations can include generating or taking a local address SA, generating a random value (SNonce), generating PMK with a received PMK_ID and built-in secret P, and generating a PTK with a hash operation using AA, SA, ANonce, SNonce, and PMK. A temporal key (TK) and KCK can be determined from PTK. UL data for AMP reader can be encrypted using TK. In the embodiment shown, AMP device can generate a corresponding MIC using KCK.

AMP device 802 can transmit a resulting access response 840. An access response 840 can have SA as a source address, AA as a destination address, and payload that includes ANonce, SNonce, the encrypted UL data, and MIC.

Upon receiving to access response 840, AMP reader 804 can transmit an access response message 842 to server 826 having encrypted data from the access response 840, including ANonce, SNonce, AA, SA, Encrypted UL data, and MIC.

Upon receiving access response message 842, a server 826 can determine whether ANonce is correct (i.e., it matches that sent in the ID response 838) and SNonce is not repeated 826-5. If either condition is not met (No from 826-5), server operations can stop 832. If SNonce and ANonce are valid (Yes from 826-5), server 826 can generate PTK and determine TK and KCK 826-6 in the same manner as AMP device 802. Using KCK, server 826 can determine if the MIC is correct 826-7. If a MIC is not correct (No from 826-7), a server 826 can send an error message 844-0 which can include an error code, or the like, in decrypted form.

If a MIC is correct (Yes from 826-7), a server 826 can decrypt UL data using TK 826-8 and determine if AMP device 102 is to receive any download (DL) data. If no DL data is needed (No from 826-9), a server 826 can send a message 844-1 that includes decrypted UL data. If DL data is needed (Yes from 826-9), a server 826 can send a message 844-1 that includes decrypted UL data, as well as TK and KCK.

Referring to FIG. 8-2, upon receiving a message with unencrypted UL data (e.g., 844-1 or 844-2), if AMP device 802 has no DL data (No from 804-13), an AMP reader 804 can stop operations 812. If AMP reader 804 has DL data (Yes from 804-13), it can encrypt DL data using TK 804-14, and transmit a DL data frame 846 to AMP device 802. A DL data frame 846 can have a source address AA, destination address SA, and a payload that includes the encrypted DL data and a corresponding MIC.

Upon receiving DL data frame 846, an AMP device 802 determine if the corresponding MIC is correct 802-7. If a MIC is not correct (No from 802-7), AMP device 802 can stop operations 808. If a MIC is correct (Yes from 802-7), AMP device 802 can decrypt DL data using TK, follow DL data instructions, and generate UL data 802-8. AMP device can encrypt the new UL data with TK 802-9, and transmit a UL data frame 848 to AMP reader 804. A UL data frame 848 can include a source address SA, a destination address AA, and a payload that includes encrypted UL data and a MIC.

Upon receiving UL data frame 848, an AMP reader 804 can determine if the corresponding MIC is correct 804-15. If such a MIC is not correct (No from 804-15), AMP reader operations can stop 832. If such a MIC is correct (Yes from 804-15), AMP reader 804 can decrypt the new UL data using TK 804-16. If there is no more DL data (No from 804-17), AMP reader operations can stop 832. If there is more DL data (Yes from 804-17), AMP reader 804 can repeat operations starting at 804-14.

In this way, a server provisioned with an AMP device can manage secure accesses between an AMP reader and the AMP device without having to provision the AMP reader.

It is understood that a system and operations like those shown in FIGS. 7-0, 7-1 and 8-0 to 8-2 may also include any of the limited provisioning features, reprovisioning capability and/or deprovisioning capability shown in FIGS. 3, 4 and 5.

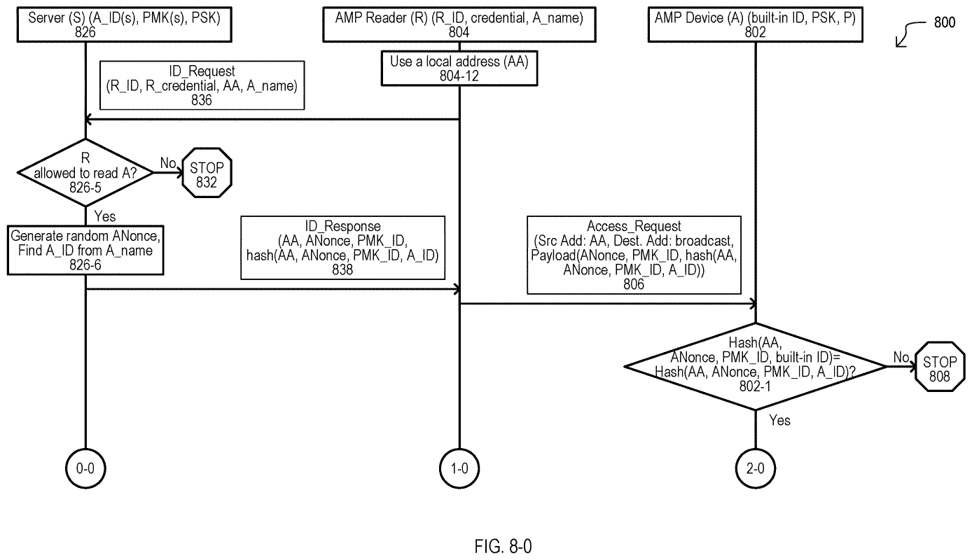

FIG. 9 is a block diagram of an AMP device 902 according to an embodiment. AMP device 902 can include controller circuits 950, RF harvester circuits 952, receive (Rx) path 954, and backscatter controller 956. Controller circuits 950 can include any suitable circuits for executing provisioning operations described for ambient devices herein, including but not limited to any of, one or more processing circuits with corresponding instructions, custom logic, programmable logic, and combinations thereof. Controller circuits 950 can include a state machine, a sequencer and/or some other type of control circuit, which may be implemented in the form of hardware, firmware, software, or combinations thereof. Optionally, an AMP device 902 can include a provisioned record 966, which can control a number of times AMP device can be provisioned, as described herein and equivalents.

AMP device 902 can be connected to an antenna system 958. Antenna system 958 can include one or more antennas, and can be tuned, or capable of being tuned by RF harvester circuits 952 and/or backscatter controller 956 to receive ambient RF energy and/or reflect ambient energy (e.g., generate backscatter messages).

Controller circuits 950 can execute any of the various operations described for AMP devices in FIGS. 1 to 8-2, and equivalents. Controller circuits 950 can, using ambient energy from RF harvester circuit 952, execute hashing operations 962 and/or one or more encryption/decryption operations 964. A secret P 960 can be a high-entropy value that is not shared by AMP device 902. Hashing operations 962 can include the generation of a shared secret (PMK) with a hash operation using secret P and a PMK_ID received in a provision request. In some embodiments, a secret P can be changed (e.g., reprovisioning, deprovisioning) and/or a provisioned record 966 can be changed through low energy (e.g., low bit or one bit) changes, as described herein and equivalents.

Controller circuits 950 can generate and transmit, via backscatter controller 956, messages, including but not limited to, provision response messages, access response messages, download data messages of corresponding requests, as described herein, or equivalents.

RF harvester circuits 952 can include circuits for receiving RF energy and converting it into energy for use by controller circuits 950 and Rx path 954. RF harvester circuits 952 can include impedance circuits that match, or can be configured to match, ambient RF energy. Rx path 954 can include circuits configured to receive messages from a reader device, such as messages according to one or more standards. In some embodiments, Rx path 954 can be compatible with one or more IEEE 802.11 wireless standards.

Backscatter controller 956 can receive transmit control (Tx_Ctrl) signals 968 from controller circuits 950. In response to Tx_Ctrl signals 968, backscatter controller 956 can alter an impedance of antenna system 958, which can result in transmission of a message (e.g., data frame) in response to ambient energy.

In this way, a wireless device can execute provisioning operations using a shared secret based on a built-in secret with ambient energy. Response messages can be generated by altering an antenna impedance.

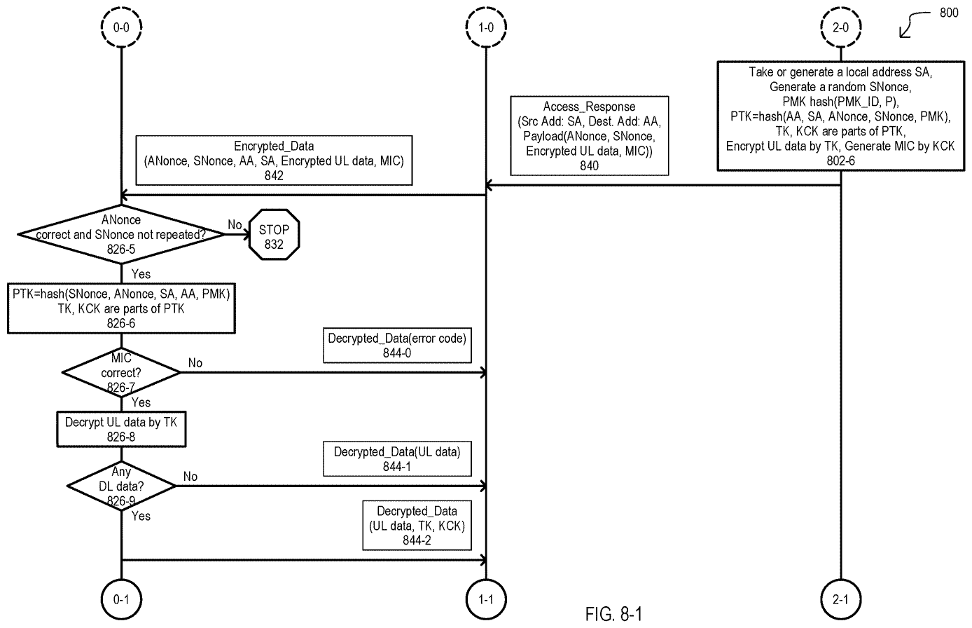

FIG. 10 is a block diagram of an ambient device 1004 according to another embodiment. Ambient device 1004 can include items like those of FIG. 9, and such like items are referred to by the same reference character but with the leading digits being “10” instead of “9”.

Ambient device 1004 can differ from that of FIG. 9 in that it can include a Tx path 1070, ambient power storage 1072, and controller circuits 1050 can include power management circuits 1074. A Tx path 1070 can enable controller circuits 1050 to transmit messages via antenna system 1058. Ambient power storage 1072 can store ambient RF energy acquired by RF harvester circuits 1052.

Power management circuits 1074 can control the distribution of ambient power received by RF harvester circuits 1052. This can include providing power to controller circuits 1050 to execute the indicated operations (e.g., hashing 1062, encryption 1064). In some embodiments, power management circuits 1074 can provide power from ambient power storage 1072 or RF harvester circuit 1052. Accordingly, when transmitting a response message via Tx path 1070, ambient device 1002 can utilize ambient power provided by RF harvester circuits 1052, energy stored in ambient power storage 1072, or a combination thereof.

In this way, a wireless device can execute provisioning operations using a shared secret based on a built-in, high entropy secret using ambient energy currently present in the environment and/or stored ambient energy.

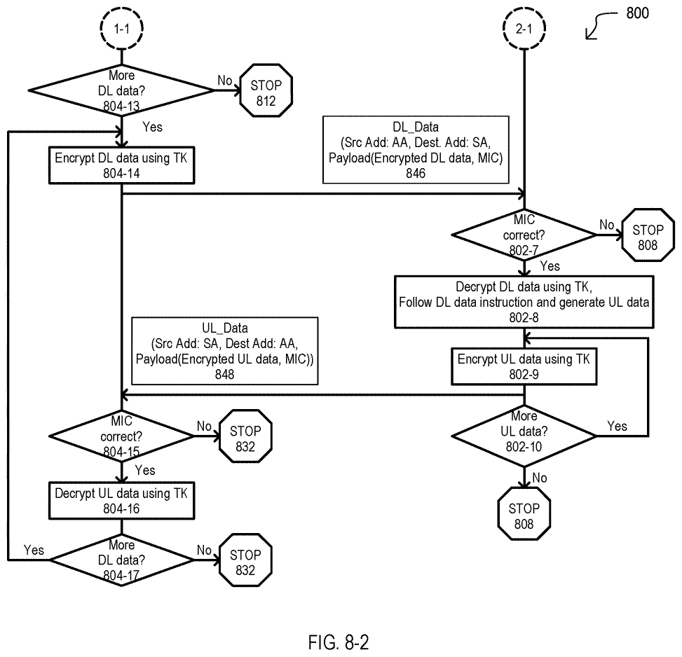

While embodiments can include ambient devices with various interconnected components, embodiments can also include ambient devices which can execute provisioning operations that require no, or little programming of nonvolatile storage elements, as described herein and equivalents. In some embodiments, such unitary devices can be advantageously compact single integrated circuits (IC). FIG. 11 shows a packaged IC device 1102/1104 that can execute communications as a reader device or ambient device according to embodiments shown herein and equivalents. While FIG. 11 shows a particular package, alternate embodiments can include any other suitable integrated circuit packaging type, as well as direct bonding of a device chip onto a circuit board or substrate.

In this way, an ambient device or reader as described herein can take the form of an integrated circuit device.

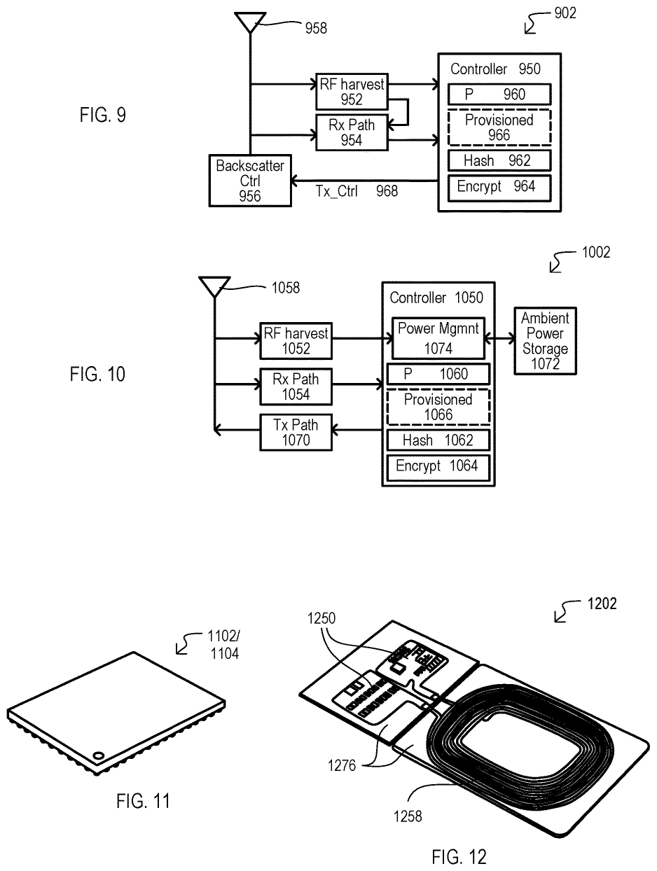

FIG. 12 is a diagram showing an ambient device 1202 according to another embodiment. An ambient device 1202 can include one or more support structures 1276, controller circuits 1250 and an antenna system 1258. Controller circuits 1250 can include one or more IC packages and well as other components. Such other components can include nonvolatile storage elements and/or OTP memory elements for storing a built-in, high-entropy secret P, a built-in device ID, and in some embodiments, a provisioned record. As noted herein, in embodiments that change a secret P and/or a provisioned record, such changes can be made via low power program operations, such as those that change only a small number of bits, including only one bit.

In some embodiments, a support structure 1276 can include one or more circuit boards. Optionally, support structure 1276 can include a surface that connects to, or contains all or a portion of antenna system 1258. An antenna system 1258 can be capable of harvesting ambient RF energy, as well as transmitting response frames, as described herein or equivalents.

In this way, an ambient device can include one or more integrated circuit devices and other circuit components mounted on a support structure connect to, or including an antenna system.

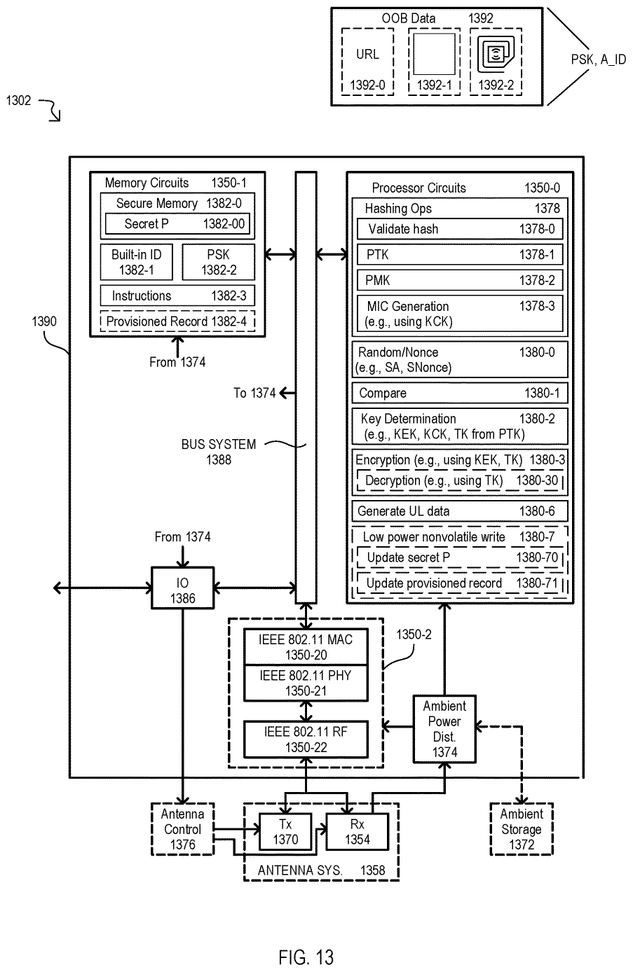

FIG. 13 is a block diagram of an AMP device 1302 according to another embodiment. In some embodiments, an AMP device 1302 can be one implementation of an AMP device shown in any of the other embodiments herein. An AMP device 1302 can include items like those of FIG. 9 or 10, and such like items are referred to by the same reference characters but with the leading digit being a “13” instead of a “9” or a “10”.

AMP device 1302 can include controller circuits (1350-0,-1,-2), IO circuits 1386 and ambient power distribution circuits 1374 connected to one another by a bus system 1388. Controller circuits can include processor circuits 1350-0, memory circuits 1350-1, and wireless circuits 1350-2. Processor circuits 1350-0 can include one or more processors that can execute instructions to provide various functions for AMP device 1350. Operations that can be provided by processor circuits 1350-0 will now be described.

Hash operations 1378 can include those described for other embodiments herein, including generating a validating hash 1378-0 (e.g., hash(AA, ANonce, PMK_ID, built-in ID), PTK 1378-1, and PMK/PMKmod) 1378-2. Further, in the embodiment shown, MIC generation 1378-3 can include a hashing operation. It is understood that any or all of hashing operations 1378 can include a cryptographic hash function that can use advantageously lightweight computation resources, such as those present in the Ascon suite.

Random generation operations 1380-0 can include the generation of nonce values (e.g., SNonce) that are non-repeating, and in some embodiments, the generation of a source address (SA). However, as noted herein, in some embodiments SA can be dictated by a request received from an AMP reader.

Compare operations 1380-1 can be used to validate requests received from an AMP reader device (e.g., provision, reprovision, deprovision, access) and make check against a provisioned record (e.g., A_provisioned, A_counter). Key determination operations 1380-2 can determine key values (e.g., KEK, KCK, TK) from a larger key value (e.g., PTK) generated by a hash operation.

Encryption operations 1380-3 can include encrypting a shared secret (PMK) and UL data for transmission to an AMP reader. In embodiments where an AMP device can receive encrypted DL data, encryption operations 1380-3 can also include decryption operations 1380-30 (e.g., decrypting DL data with TK). As noted herein, such encryption/decryption operations can utilize functions that require advantageously lightweight computation resources (e.g., from the Ascon suite).

UL data can be generated 1380-6. UL data can be generated/selected in any suitable fashion. In some embodiments, processor circuits 1350-0 can periodically generate UL data (e.g., sensor data), and an access request from an AMP reader can indicate which particular UL data are to be encrypted and returned. However, in other embodiments, UL data can be generated in response to an access request from an AMP reader.

In some embodiments, processor circuits 1350-0 can execute low-power nonvolatile write operations 1380-7. Such operations can include write operations to nonvolatile memory cells of memory circuits 1350-1 that change a relatively small number of bits in a stored value, including only one bit. Such write operations 1380-7 can include updates to a built-in secret P 1380-70 and/or updates to a provisioned record 1380-71.

Memory circuits 1350-1 can include nonvolatile memory and any other suitable memory circuits, including volatile memory. Nonvolatile memory can be reprogrammable, OTP or combinations thereof. In the embodiment shown, memory circuits 1350-1 can include secure memory 1382-0 that can store built-in, high-entropy secret P 1382-00. A secure memory 1382-0 can be a memory that is accessible only by predetermined processes of AMP device 1302.

Memory circuits 1350-1 can also store, in a nonvolatile manner, a built-in ID 1382-1, PSK 1382-2, and instructions 1382-3 executable by processor circuits 1350-0 to provide the various operations described. In some embodiments, a provisioned record 1382-4 can be used that is also stored in a nonvolatile memory.

Wireless circuits 1350-2 can include circuits for transmitting and receiving messages according to one or more IEEE 802.11 wireless standards. In the embodiment shown, wireless circuits 1350-2 can include MAC layer circuits 1350-20, physical layer (PHY) circuits 1350-21, and RF circuits 1350-22.

IO circuits 1386 can input or output signals that can enable control of an AMP device 1302 from external sources. In some embodiments, IO circuits 1386 can include serial communication circuits, including but not limited to interfaces compatible with a serial digital interface (SDI), universal serial bus (USB), universal asynchronous receiver transmitter (UART), I2C, or I2S.

Ambient power distribution circuits 1374 can receive ambient power and distribute it to various sections of AMP device 1302. Ambient power distribution circuits 1374 can receive ambient power from antenna system 1358, optional ambient storage 1372, or combinations thereof.

In some embodiments, controller circuits (1350-0/1/2), IO circuits 1386, and ambient power distribution circuits 1374 can be formed with a same IC substrate 1390.

AMP device 1302 can be connected to an antenna system 1358 that includes one or more Rx paths 1354 and one or more Tx paths 1370. A Rx path 1354 can receive frames from an AMP reader, including any of: provision, deprovision, reprovision and access requests. An Rx path 1354 can also receive ambient power and transmit such power to ambient power distribution circuits 1374. A Tx path 1370 can transmit response frames, including but not limited to provision, deprovision, reprovision, access, and DL data responses.

In some embodiments, AMP device 1302 can be connected to and/or include an antenna control system 1376. An antenna control system 1376 can alter an impedance of a receive path 1354 and optionally a transmit path 1370. In some embodiments, antenna control system 1376 can receive control signals from processor circuits 1350-0 via IO circuits 1386. However, in alternate embodiments such control signals can be received directly from processor circuits 1350-0. In some embodiments, antenna control circuits 1376 can alter an impedance of a Rx path 1354 to generate a response message using ambient energy (e.g., modulating reflected energy).

Referring still FIG. 13, an AMP device 1302 can include, or be associated with, OOB data 1392. OOB data 1392 can include, but is not limited to, information included with an AMP device 1302 and/or information included with the packaging of AMP device 1302. OOB data 1392 can be accessed, directly or indirectly, by an AMP reader as described herein and equivalents. In the embodiment of FIG. 13, OOB data 1392 can include any of: a URL 1392-0, a QR code 1392-1, and an RFID 1392-2. However, OOB data can take any other suitable form.

In this way, an AMP device can be compatible with one or more IEEE 802.11 wireless standards, and can execute provisioning operations using a high-entropy shared secret generated with a high-entropy, built-in, non-shared secret.

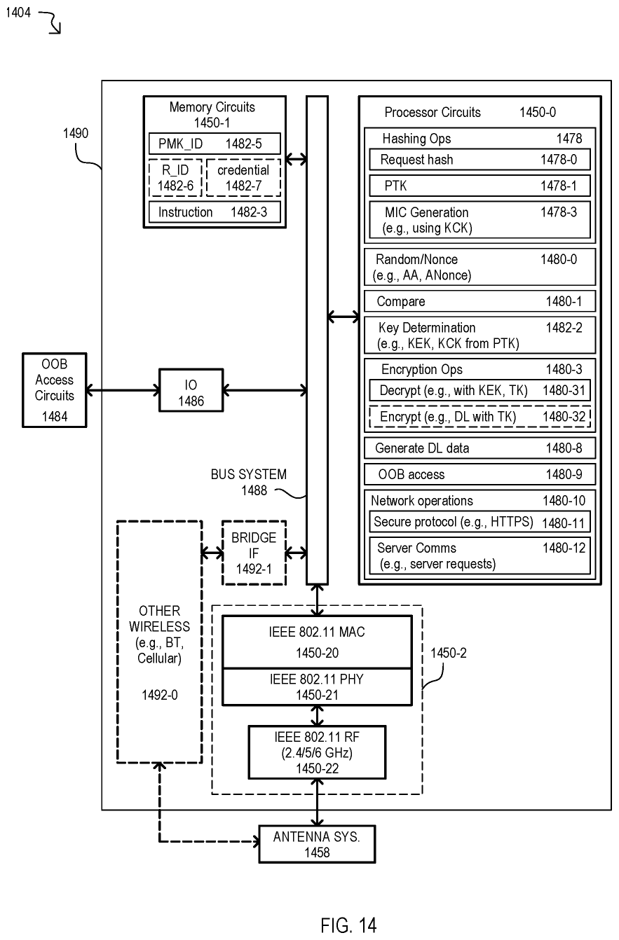

FIG. 14 is block diagram of an AMP reader 1404 according to another embodiment. A AMP reader 1402 can include items like those of FIG. 13, and such like items are referred to by the same reference character but with the leading digits being “14” instead of “13”.

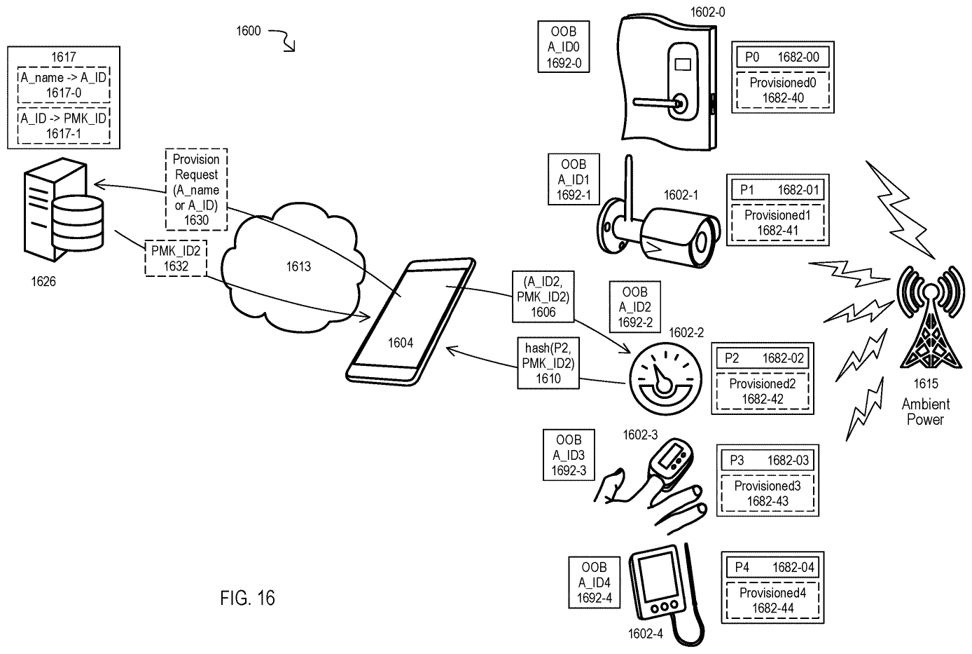

FIG. 14 can differ from FIG. 16 in that hashing operations 1478 can generate a request hash, that can be included in request frames to an AMP device, using a value (e.g., A_ID) acquired through an OOB method.

Compare operations 1480-1 can be used to determine if a nonce received in a response matches that previously sent in a request (e.g., ANonce) and/or if a received nonce (e.g., SNonce) is not a repeat value. In addition, compare operations 1480-1 can determine if a received MIC matches a MIC generated for the same message. Encryption operations 1480-3 can include decrypting a shared secret (PMK) and UL data received from an AMP device. In embodiments where an AMP reader 1404 sends DL data, encryption operations 1480-3 can also include encryption operations 1480-40 (e.g., encrypting DL data with TK).

Unlike FIG. 13, operations of processor circuits 1450-0 can include generating DL data 1480-8, OOB access operations 1480-9, and network operations 1480-10. In some embodiments, DL data include data that directs operations for an AMP device. OOB access operations 1480-9 can include any of those described herein, or equivalents. Network operations 1480-10 can enable AMP reader 1404 to communicate with a server, and can include one or more security protocols (e.g., HTTPS) 1480-11 and the generation of server requests 1480-12, as well as the processing of corresponding server responses.

Memory circuits 1450-1 can store one or more key identification values (PMK_ID) 1482-2 as well as instructions 1482-3 for execution by processor circuits 1450-0 for the various operations described. Memory circuits 1450-1 can optionally store a device ID 1482-8 and credential 1482-7 for validation with a server or the like.

An AMP reader 1402 can include, or be connected to, OOB access circuits 1484, for enabling OOB methods as described herein or equivalents.

Optionally, an AMP reader 1404 can include other wireless circuits 1492-0 for communicating according to additional wireless standards, including but not limited to, Bluetooth and/or Cellular. Other wireless circuits 1492-0 can be connected with bus system 1488 by a bridge interface (IF) 1492-1.

In this way, a AMP reader can be compatible with one or more IEEE 802.11 wireless standards, and can execute provisioning operations with an AMP device in which a high-entropy shared secret is received from AMP device that is generated with a built-in high-entropy secret of the AMP device.

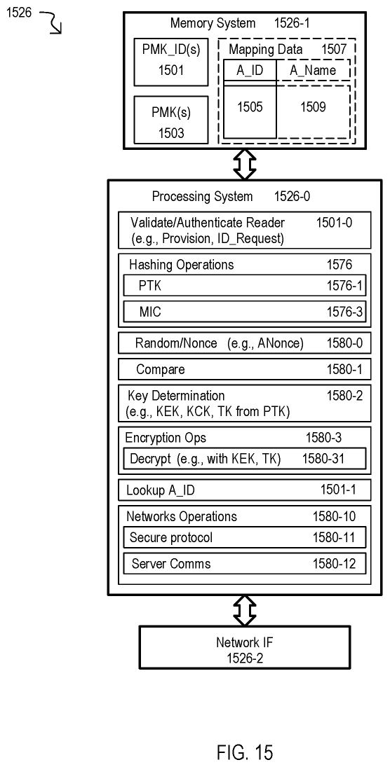

FIG. 15 is a block diagram of a server 1526 according to an embodiment. A server 1526 can include a processing system 1526-0, memory system 1526-1, and network IF 1526-2. Processing system 1526-0 can include one or more computing systems that can execute instructions to provide various server operations in support of AMP device access by an AMP reader as described herein and equivalents. Operations that can be provided by processing system 1526-0 will now be described.

Validation operations 1501-0 can determine if a received AMP reader request is valid, and can include any of those described herein, including but not limited to, processing a credential and ID (e.g., user ID or R_ID) from an AMP device. Hashing operations 1576 can include those as described herein, including generating a PTK 1576-1 and/or MIC 1576-3. Compare operations 1580-1 can be used to determine if a nonce received in a response matches that previously sent in a request (e.g., ANonce). Key determination 1580-2 can include operations described herein. Encryption operations 1580-3 can include decrypting a shared secret (PMK) and UL data received from an AMP device via an AMP reader.

Processing system 1526-0 can further include look-up operations 1501-1 that can access a memory system 1526-1 do determine an AMP device ID (A_ID) from a meaningful name or other information. Network operations 1580-10 can include, but are not limited to, executing a secure protocol (e.g., HTTPS) 1580-11 for communications with AMP readers and server communications 1580-12 which can include processing AMP reader requests and generating corresponding server responses.

Memory system 1526-1 can store values for access by processing system 1526-0 when communicating with an AMP reader. Memory system 1526-1 can store one or more key identification values (PMK_ID) 1501 and AMP device IDs (A_ID) 1505. In some embodiments, memory system 1526-1 can include a mapping data structure 1507 that can enable a server to determine an AMP device ID (A_ID) 1505 from a meaningful name (A_name) 1509 provided in a server request from an AMP reader. In some embodiments, memory system 1526-1 can store shared secrets (PMKs) 1503 received in a provisioning operation with an AMP device.

A network IF 1526-2 can enable communications between server 1526 and AMP readers. In some embodiments, a network IF 1526-2 can be connected to one or more networks, including the Internet.

In this way, a server can store reader device IDs and credentials to validate and related requests from AMP readers, as well as AMP device IDs and shared secrets with AMP devices.

FIG. 16 shows a system 1600 according to a further embodiment. A system 1600 can include an AMP reader 1604 and a number of AMP devices 1602-0 to 1602-4. AMP devices (1602-0 to 1602-4) can each store a secret P (1682-00 to 1682-04) and have associated OOB information (1692-0 to 1692-4). As understood from embodiments herein, secrets P (1682-00 to 1682-04) can be high-entropy values that are not shared, but can be used to generate a shared secret (e.g., PMK) for use in provisioning operations. Optionally, an AMP device (1602-0 to 1602-4) can maintain a provisioning record (1682-40 to 1682-44) for limiting the number of times an AMP device (1602-0 to 1602-4) can be provisioned.

FIG. 16 shows a provisioning operation for AMP device 1602-2 by illustration. An AMP reader 1604 can initiate a provisioning operation by accessing OOB information (1692-0 to 1692-5) for a corresponding AMP device (1602-0 to 1602-5). OOB information can include a device ID (A_ID2) for the AMP device 1602-2 of interest. Using OOB information, AMP reader 1604 can generate a provision request 1606 that can include the A_ID2 as well as a key ID (PMK_ID2). In response to such a request, AMP device 1602-2 can generate a shared secret with a hash operation that uses its secret (P2) and the PMK_ID2. Such a shared secret can be encrypted using OOB information and, using ambient power 1615, transmitted to the AMP reader 1604. AMP reader 1604 can decrypt and store the shared secret using OOB information. The shared secret can be used to secure further communications with AMP device 1602-2.

In addition or alternatively, an AMP reader 1604 can send a server request 1630 to a server 1626 over a network 1613. A server request 1630 can include a way of identifying an AMP device 1602-2, including but not limited to its A_ID2 or a meaningful name by which the server 1626 can determine A_ID2.

A server 1626 can use a look-up operation 1617 to determine a PMK_ID for the indicated AMP device. A look-up operation 1617 can use A_ID directly 1617-1 or indirectly 1617-0 using a meaningful name. A server 1626 can then return a PMK_ID2 to an AMP reader 1604, which can then generate a provision request.

In the embodiment shown, AMP devices (1602-0 to 1602-4) can be “Internet-of-things” (IoT) type devices, including but not limited to: security devices 1602-0/1, instrumentation devices 1602-2, and medical devices 1602-3/4. However, such AMP devices are provided by way of example, and any other suitable AMP device can execute provisioning and related operations as described herein and equivalents.

In this way, an AMP reader can execute a provisioning operation with any various AMP devices that results in an AMP device generating and encrypting a shared secret using a built-in, non-shared secret.

Embodiments can include methods, devices and systems in which, by operation of wireless circuits of an AMP device, by operation of wireless circuits of an AMP device, receiving at least a provision request frame having at least AA, ANonce, and PMK_ID. A method can further include, by operation of processor circuits of the AMP device and using ambient power, generating SNonce, computing a PTK using at least ANonce, SNonce, AA, SA, and a PSK, deriving at least a KEK from the PTK, and computing a PMK using PMK_ID and a secret P. A secret P can be stored in the AMP device in a nonvolatile fashion and not shared by the AMP device. Processor circuits can further encrypt PMK using the KEK. By operation of the wireless circuits and using ambient power, a provision response frame can be transmitted that includes at least SNonce and the encrypted PMK.

Embodiments can include methods, devices and systems having memory circuits configured to store at least a secret P that is not shared with other devices; processor circuits coupled to the memory circuits and configured to generate SNonce, compute a PTK using at least SNonce, a received nonce (ANonce), a received source address (AA), SA, and a PSK. Processor circuits may further derive a KEK from the PTK, and compute a PMK using a received PMK_ID and secret P, and encrypt PMK using the KEK. Wireless circuits can be configured to wirelessly receive a provision request frame that includes AA as a source address, ANonce, and PMK_ID, and wirelessly transmit a provision response frame that includes at least SNonce and the encrypted PMK. Processor circuits and wireless circuits can be powered with ambient energy harvested from an operating environment of the device.

Embodiments can include methods, devices and systems having an ambient device powered with ambient energy harvested from an operating environment that includes a controller configured to store at least a secret P in a nonvolatile fashion that is not shared with other devices, wirelessly receive a provision request frame having AA, ANonce, and a PMK_ID, compute a PTK using at least ANonce, SNonce, AA, an address for the ambient device, and a PSK, derive at least a KEK from the PTK, compute a PMK using PMK_ID and secret P, encrypt PMK using the KEK, and wirelessly transmit a provision response frame that includes at least SNonce and the encrypted PMK. An antenna system may also be included.

Methods, devices and systems according to embodiments can include provision request frame having a broadcast frame destination address and including a received hash result. By operation of the processor circuits of an AMP device and using ambient power, a first hash result can be computed with a first hash operation using at least AA, PMK_ID, ANonce and an ID value built-in to the AMP device. A first hash result can be compared with a received hash result. By operation of the wireless circuits, in response to a first hash result matching a received hash result, a provision response frame can be wirelessly transmitted. In response to a first hash result not matching a received hash result, the provision response frame may not be wirelessly transmitted.

Methods, devices and systems according to embodiments can include a secret P and shared secret PMK having no less than 128-bits.

Methods, devices and systems according to embodiments can include, by operation of processor circuits, further determining a confirmation key (KCK) from the PTK and generating a message integrity code (MIC) for the provision response frame using the PTK. A provision response frame can include the MIC.

Methods, devices and systems according to embodiments can include, prior to generating a PTK, by operation of the processor circuits and using ambient power, in response to a provisioned record not having a predetermined value, transmitting the provision response frame and subsequently changing the provisioned record. In response to the provisioned record having the predetermined value, ceasing operations. A provisioned record can indicate a number of times an AMP device has been provisioned.

Methods, devices and systems according to embodiments can include changing a provisioned record by changing no more than four bits of the provisioned record.

Methods, devices and systems according to embodiments can include a provisioned record being a counter value. Changing a provisioned record can include changing a counter value by no more than one bit.

Methods, devices and systems according to embodiments can include, by operation of wireless circuits, receiving a provision change frame. By operation of the processor circuits and using ambient power, at least a PMK_ID can be determined from a payload of a provision change frame and a secret P can be change by at least one bit.

Methods, devices and systems according to embodiments can include changing a secret P by no more than four bits

Methods, devices and systems according to embodiments can include, a provision change frame being a reprovisioning request frame. By operation of the processor circuits and using ambient power, a reprovisioned pairwise master key (PMK2) can be generated using PMK_ID and a changed secret P, and PMK2 can be encrypted. By operation of the wireless circuits and using ambient power, a reprovision response frame can be wirelessly transmitting that includes at least the encrypted PMK2.

Methods, devices and systems according to embodiments can include, a provision change being a deprovisioning request frame. By operation of the wireless circuits and using ambient power, a deprovision response frame can be wirelessly transmitting that can confirm that secret P has been changed.

Methods, devices and systems according to embodiments can include, a provision request frame having a broadcast destination address and including a received hash result. Processor circuits can be configured to compute a first hash result using at least AA, PMK_ID, ANonce and an ID value built-in to a device. A first hash result can be compared with a received hash result. Wireless circuits can be configured to, in response to a first hash result matching a received hash result, wirelessly transmit a provision response frame, and, in response to a first hash result not matching a received hash result, not transmit a provision response frame.

Methods, devices and systems according to embodiments can include, by operation of processor circuits and using ambient power, in response to a provisioned record not having a predetermined value, transmitting a provision response frame and subsequently changing the provisioned record, and in response to the provisioned record having the predetermined value, ceasing operations and not transmitting the provision response.

Methods, devices and systems according to embodiments can include, a provision request frame having a broadcast destination address and including a received hash result. A controller can be configured to compute a first hash result using at least AA, PMK_ID, ANonce and an ID value built-in to the ambient device, and compare a first hash result with a received hash result. In response to a first hash result matching a received hash result, a provision response frame can be wirelessly transmitted. In response to a first hash result not matching a received hash result, a provision response frame may not be wirelessly transmitted.

Methods, devices and systems according to embodiments can include a provision request and response being transmitted according to a first wireless standard. A reader device can be configured to access at least a PSK through an OOB method different from the first wireless standard, and transmit the provision request.

Methods, devices and systems according to embodiments can include a controller configured to store a provisioned record in a nonvolatile fashion, upon receiving a provision request, in response to the provisioned record not having a predetermined value, transmitting the provision response frame and subsequently changing the provisioned record, and in response to the provisioned record having the predetermined value, ceasing operations and not transmitting the response frame.

Methods, devices and systems according to embodiments can include, a controller configured to, in response to wirelessly receiving a provision change frame, determining at least the PMK_ID from the provision change frame, and changing secret P by no more than four bits.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A method, comprising:
by operation of wireless circuits of an ambient powered (AMP) device, receiving at least a provision request frame having at least a source address (AA), a first nonce (ANonce), and a key identification (ID) value (PMK_ID);
by operation of processor circuits of the AMP device and using ambient power, generating a second nonce (SNonce),
computing a pairwise transient key (PTK) using at least ANonce, SNonce, AA, an address for the AMP device (SA), and a pre-shared key (PSK),
deriving at least an encryption key (KEK) from the PTK, and
computing a pairwise master key (PMK) using PMK_ID and a secret value (P), the secret value P being stored in the AMP device in a nonvolatile fashion and not shared by the AMP device, and
encrypting PMK using the KEK; and
by operation of the wireless circuits and using ambient power, wirelessly transmitting a provision response frame that includes at least SNonce and the encrypted PMK.

2. The method of claim 1, wherein:
the provision request frame has a broadcast frame destination address and further includes a received hash result;
by operation of the processor circuits of the AMP device and using ambient power, computing a first hash result with a first hash operation using at least AA, PMK_ID, ANonce and an ID value built-in to the AMP device, and
comparing the first hash result with the received hash result; and
by operation of the wireless circuits
in response to the first hash result matching the received hash result, wirelessly transmitting the provision response frame, and
in response to the first hash result not matching the received hash result, not transmitting the provision response frame.

3. The method of claim 1, wherein P and PMK are no less than 128-bits.

4. The method of claim 1, wherein:
by operation of the processor circuits,
further determining a confirmation key (KCK) from the PTK and
generating a message integrity code (MIC) for the provision response frame using the PTK; and
the provision response frame includes the MIC.

5. The method of claim 1, further including:
prior to generating the PTK, by operation of the processor circuits and using ambient power,
in response to a provisioned record not having a predetermined value, transmitting the provision response frame and subsequently changing the provisioned record, and
in response to the provisioned record having the predetermined value, ceasing operations; wherein
the provisioned record indicates a number of times the AMP device has been provisioned.

6. The method of claim 5, wherein:
changing the provisioned record includes changing no more than four bits of the provisioned record.

7. The method of claim 5, wherein:
the provisioned record is a counter value; and
changing the provisioned record includes changing the counter value by no more than one bit.

8. The method of claim 1, further including:
by operation of the wireless circuits, receiving a provision change frame;
by operation of the processor circuits and using ambient power,
determining at least the PMK_ID from a payload of the provision change frame, and
changing P by at least one bit.

9. The method of claim 8, wherein:
changing P consists of changing P by no more than four bits

10. The method of claim 8, further including:
the provision change frame is a reprovisioning request frame;
by operation of the processor circuits and using ambient power, generating a reprovisioned pairwise master key (PMK2) using PMK_ID and the changed P, and encrypting PMK2; and
by operation of the wireless circuits and using ambient power, wirelessly transmitting a reprovision response frame that includes at least the encrypted PMK2.

11. The method of claim 8, further including:
the provision change frame is a deprovisioning request frame; and
by operation of the wireless circuits and using ambient power, wirelessly transmitting a deprovision response frame that can confirm that P has been changed.

12. A device comprising:
memory circuits configured to store at least a secret value (P) that is not shared with other devices;
processor circuits coupled to the memory circuits and configured to generate a nonce (SNonce),
compute a pairwise transient key (PTK) using at least SNonce, a received nonce (ANonce), a received source address (AA), an address for the device (SA), and a pre-shared key (PSK),
derive at least an encryption key (KEK) from the PTK, and
compute a pairwise master key (PMK) using a received key identification (ID) value (PMK_ID) and P, and
encrypt PMK using the KEK; and
wireless circuits configured to
wirelessly receive a provision request frame that includes AA as a source address, ANonce, and PMK_ID, and
wirelessly transmit a provision response frame that includes at least SNonce and the encrypted PMK; wherein
the processor circuits and wireless circuits are powered with ambient energy harvested from an operating environment of the device.

13. The device of claim 12, wherein:
the provision request frame has a broadcast destination address and further includes a received hash result;
the processor circuits are further configured to
compute a first hash result using at least AA, PMK_ID, ANonce and an ID value built-in to the device, and
compare the first hash result with the received hash result;
the wireless circuits are further configured to
in response to the first hash result matching the received hash result, wirelessly transmit the provision response frame, and
in response to the first hash result not matching the received hash result, not transmit the provision response frame.

14. The device of claim 12, wherein P and PMK are no less than 128-bits.

15. The device of claim 12, wherein:
by operation of the processor circuits and using ambient power,
in response to a provisioned record not having a predetermined value, transmitting the provision response frame and subsequently changing the provisioned record, and
in response to the provisioned record having the predetermined value, ceasing operations and not transmitting the provision response; wherein
the provisioned record indicates a number of times the device has been provisioned.

16. A system, comprising:
an ambient device powered with ambient energy harvested from an operating environment that includes
a controller configured to
store at least a secret value (P) in a nonvolatile fashion that is not shared with other devices,
wirelessly receive a provision request frame having a source address (AA), a first nonce (ANonce), and a key identification (ID) value (PMK_ID),
compute a pairwise transient key (PTK) using at least ANonce, SNonce, AA, an address for the ambient device, and a pre-shared key (PSK),
derive at least an encryption key (KEK) from the PTK,
compute a pairwise master key (PMK) using PMK_ID and P,
encrypt PMK using the KEK, and
wirelessly transmit a provision response frame that includes at least SNonce and the encrypted PMK; and
an antenna system.

17. The system of claim 16, wherein:
the provision request frame has a broadcast destination address and further includes a received hash result; and
the controller is further configured to
compute a first hash result using at least AA, PMK_ID, ANonce and an ID value built-in to the ambient device,
compare the first hash result with the received hash result,
in response to the first hash result matching the received hash result, wirelessly transmit the provision response frame, and
in response to the first hash result not matching the received hash result, not transmit the provision response frame.

18. The system of claim 16, further including:
the provision request and response are transmitted according to a first wireless standard; and
a reader device configured to
access at least the PSK through an out-of-band (OOB) method different from the first wireless standard, and
transmit the provision request.

19. The system of claim 16, wherein:
the controller is further configured to
store a provisioned record in a nonvolatile fashion,
upon receiving a provision request,
in response to the provisioned record not having a predetermined value, transmitting the provision response frame and subsequently changing the provisioned record, and
in response to the provisioned record having the predetermined value, ceasing operations and not transmitting the response frame; wherein
the provisioned record indicates a number of times the ambient device has been provisioned.

20. The system of claim 16, wherein:
the controller is further configured to
in response to wirelessly receiving a provision change frame,
determine at least the PMK_ID from the provision change frame, and
change P by no more than four bits.
